(19) United States
(12) Patent Application Publication
(10) Pub. No.: US 2019/0041364 A1
(43) Pub. Date: Feb. 7, 2019

(54) System and Method for Detecting Failed Electronics Using Acoustics

(71) Applicants: Russell Shannon, Ocean Gate, NJ (US); Justin Tallent, Haddon Heights, NJ (US); Vontrelle Collins, Brick, NJ (US); John Carswell, Newtown, PA (US); Gregory Zucaro, Toms River, NJ (US)

(72) Inventors: Russell Shannon, Ocean Gate, NJ (US); Justin Tallent, Haddon Heights, NJ (US); Vontrelle Collins, Brick, NJ (US); John Carswell, Newtown, PA (US); Gregory Zucaro, Toms River, NJ (US)

(73) Assignee: United States of America as represented by the Secretary of the Navy, Patuxent River, MD (US)

(21) Appl. No.: 15/666,857

(22) Filed: Aug. 2, 2017

(51) Int. Cl. G01N 29/44; G01N 29/40

(52) U.S. Cl. CPC G01N 29/4427; G01N 29/40; G01N 2291/102; G01N 2291/2697; G01N 2291/045; G01N 29/4481

(57) ABSTRACT

An apparatus and method for detecting failed electronics using acoustics. The method comprising directing an acoustic wave toward a circuit component to be tested such that the acoustic wave is reflected off the circuit component, receiving the reflected acoustic wave, amplifying the reflected acoustic wave, and comparing the reflected acoustic wave with known acoustic waves to determine if the circuit component is operating properly. The apparatus comprising a data acquisition system for acquiring data, an X-Y-Z positioner to position two transducers and to hold the circuit component, and software to post-process and analyze the data. The data acquisition system further includes an oscilloscope, a puller-receiver, two air-coupled transducers, and an amplifier.

### STATEMENT OF GOVERNMENT INTEREST

The invention described herein may be manufactured and used by or for the Government of the United States of America for governmental purposes without payment of any royalties thereon or therefor.

### BACKGROUND

Currently, in order to diagnose a circuit card failure in the United States Navy and Marine Corps, machines that physically and electrically probe locations on a circuit card and take measurements are used. However, prior to utilizing these machines, the “conformal coating” (a coating around the circuit card made of silicone or polyurethane) must be removed from the card, then reapplied after testing and/or repair. Currently, outside of the United States military, complex laboratory systems are used to identify specific failure modes through acoustic imaging and analysis systems. These systems utilize technologies such as Scanning Acoustic Microscopy (SAM) and Laser Doppler Vibrometry to produce images of circuits and chips for failure mode and fault analysis. These images are analyzed by software to find the source of a fault or failure. These techniques are costly and cannot be utilized in a military operating environment because of system size, complexity, and fragility.

### SUMMARY

The present invention is directed to a method and system for detecting failed electronics using acoustics with the needs enumerated above and below.

The present invention is directed to a method for detecting failed electronics using acoustics, the method comprising directing an acoustic wave toward a circuit card or circuit component to be tested such that h acoustic wave is reflected off the circuit card or circuit component, receiving the reflected acoustic wave amplifying the reflected acoustic wave and comparing the reflected acoustic wave with known acoustic wave properties to determine if the circuit card or circuit component is operating properly.

The present invention is directed to a method of fault detection using air-coupled A-mode acoustic testing and analysis to look for density changes in the material of a circuit or circuit component. These density changes are used as an indication of a fault or failure, in that circuit or circuit component. as the reflected acoustic wave will differ depending on density and structure of the material from which it is reflected.

It is a feature of the present invention to provide a method and system for detecting failed electronics using acoustics that is less expensive and less complex than currently available methods.

It is a feature of the present invention to provide a method and system for detecting failed electronics that does not require a user to remove and reapply a conformal coating on a circuit card.

It is a feature of the present invention to provide a method and system for detecting failed electronics that does not require fluid coupling, but rather utilizes two air-coupled transducers. Generally, acoustic transducers are used to convert electrical energy into mechanical (sound) energy, and visa versa. Sound is a mechanical vibration of the air. In this method, one transducer is used to generate an acoustic wave by converting an electrical pulse from a pulser-receiver into an acoustic wave with a frequency in the megahertz range. Another transducer is used to turn the received acoustic wave (vibrations of the air) into electrical energy that can be captured digitally and analyzed to determine the health of the circuit component under test.

### DRAWINGS

These and other features, aspects and advantages of the present invention will become better understood with reference to the following description and appended claims, and accompanying drawings wherein:

FIG. 1 is a diagram illustrating the flow of information and signals between hardware and software components an automated embodiment of the system; and,

FIGS. 2A, 2B, and 2C are flowcharts depicting the overall process for acquiring and analyzing data from a group of components using an automated embodiment of the system.

### DESCRIPTION

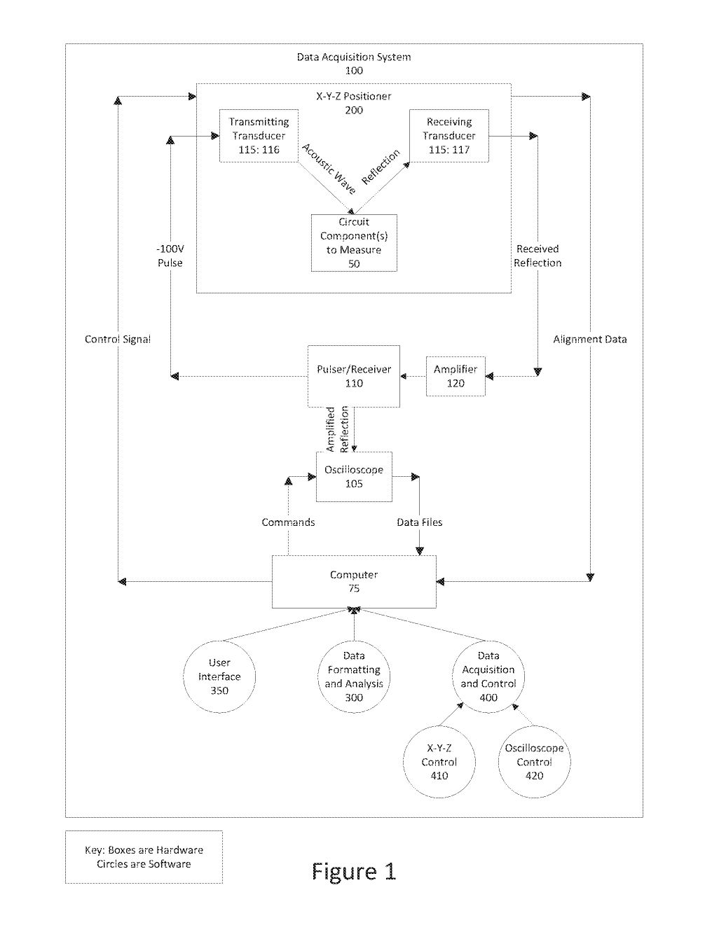

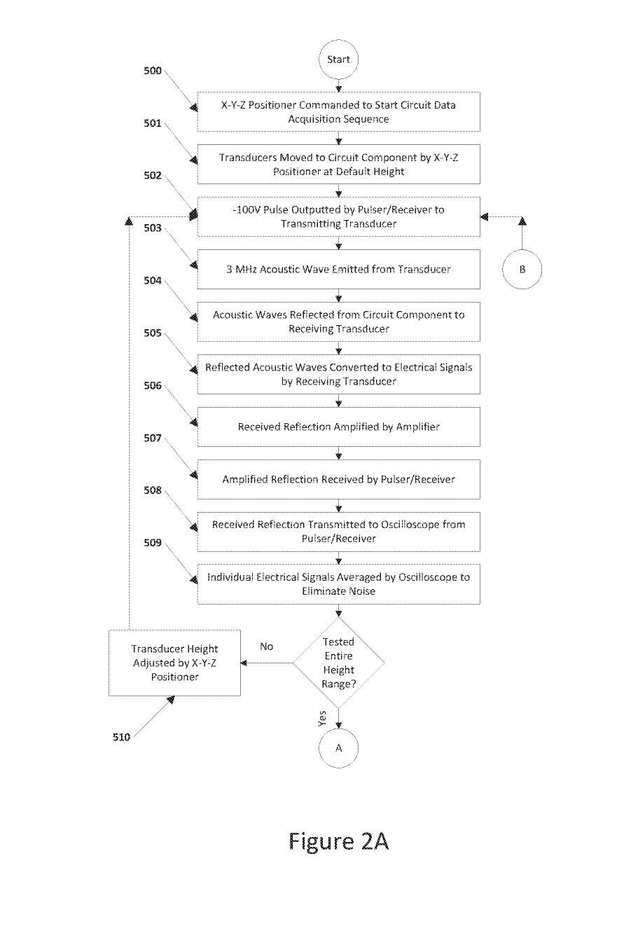

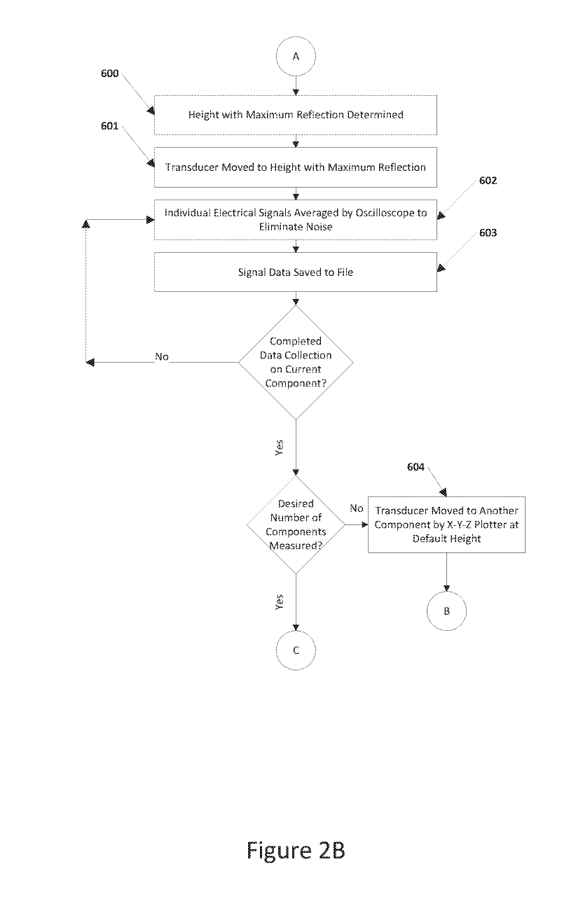

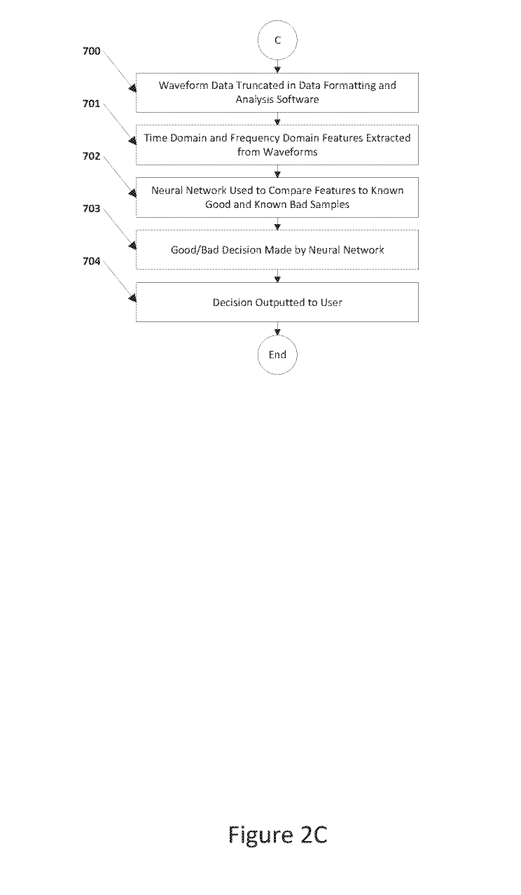

The preferred embodiments of the present invention are illustrated by way of example below and in FIGS. 1, 2A, 2B, and 2C. FIG. 1 shows the flow of information to a fully automated embodiment of this system. In other embodiments, the positioning of the transducers and the control of the oscilloscope may be performed manually. Alternatively, the operating frequency of the transducers may vary in the megahertz range. In other embodiments, the transducers may require being driven by a voltage different from the −100V pulse output by the pulser-receiver described here.

In the description of the present invention, the invention will be discussed in an aircraft and ship environment; however, this invention can be utilized for any type of application that requires use of a method or system for detecting failed electronics.

As shown in FIG. 1, in one of the embodiments of the invention, the basic components of the invention are a data acquisition system 100 and a rig or X-Y-Z positioner 200 to position two transducers 115 and to hold the circuit card (or test piece) 50 under test. The system is operated by data acquisition and control software 400, and data formatting and analysis software 300 to post-process and analyze the data. The data acquisition system 100 includes an oscilloscope 105, a pulser-receiver 110, two air-coupled acoustic transducers 115 (held by a transducer holder) built to operate at 3 MHz, an amplifier 120, and a personal computer 75. There are two pieces of software (data formatting and analysis software 300) running on the personal computer 75 to analyze data. One piece of software is used to analyze data from a single waveform from a component, circuit card 50, or test piece of unknown health and to provide a user a determination of health state of that component(i.e., “Good” or “Failed”). The second software program uses a priori knowledge of the health of the components being tested. This piece of software is designed to analyze the data from multiple waveforms in a population and determine the accuracy of the system itself. The data acquisition and control software 400 runs on the personal computer 75 and contains two components referred to as an X-Y-Z control component 410 and an oscilloscope control component 420. The X-Y-Z control component 410 is used to control the X-Y-Z positioner 200. while the oscilloscope control component 420 controls the oscilloscope 105. Additionally, there is a user interface 350 that allows the operator to run the system. In another embodiment of this system, positioning of the transducers 115 and control of the oscilloscope 105 may be done manually.

In one of the embodiments, the following method, shown in detail in FIGS. 2A, 2B, and 2C is used to acquire data in the automated embodiment of the system As shown in FIG. 2A, all equipment is turned on (start)and the X-Y-Z positioner 200 is commanded to start the circuit data acquisition sequence (action 500 in FIG. 2A). The computer 75 will command the X-Y-Z positioner 200 to move to a pre-programmed position above a circuit card 50, component, or test piece of interest. Next, the transducers 115 are lowered to a default height by the X-Y-Z positioner 200 (action 501). The pulser-receiver 110 will then start outputting a voltage pulse to a transmitting transducer 116 (one of the two air-coupled acoustic transducers 115) (action 502), causing the transmitting transducer 116 to output 3 MHz sound (action 503). A receiving transducer 117 (the other air-couple acoustic transducer 115) will begin receiving any acoustic waves that were reflected from the test piece or circuit card 50 (action 504). The reflected acoustic waves are then converted by the receiving transducer 117 into an electrical signal (action 505). The reflections/electrical signals are amplified by the amplifier 120 (action 506), then received by the pulser-receiver 110 (action 507), and then fed into the oscilloscope 105 (action 508) to be measured. The oscilloscope 105 digitizes the incoming signal by sampling it at a user-defined frequency in the gigahertz range and displays it to the screen of the oscilloscope 105. In order to eliminate signals are captured from the oscilloscope 105 after the oscilloscope 105 has averaged the received signals a user-defined number of times (action 509). Next, the transducers 115 are moved through a predetermined height range below and above the default height (action 510). In this embodiment, the range is from 120 mils above to 120 mils below the default height, in 16 mil increments. A “mil” may be defined as, but without limitation, a unit representing one thousandth of an inch. The acoustic fiction's amplitude is measured at each height and stored. After each height in the range is collected, a maximum reflection amplitude is found by searching the height array for the maximum height recorded (action 600 in FIG. 2B). Once the maximum reflection amplitude is determined, the transducers are then moved to that height (action 601). Subsequently, the waveform data measured by the oscilloscope 105 is averaged in order to eliminate noise (action 602). The digitized waveform data is then saved to a file (action 603). If a bulk analysis control program is executing, the X-Y-Z positioner 200 will then move to another circuit card 50 or circuit component (action 604) and start the process over (action 502 in FIG. 2A).

In the current invention, the transmitting transducer 116 is used to generate an acoustic wave by converting an electrical pulse from a pulser-receiver 110 into an acoustic wave with a frequency in the megahertz range. The receiving transducer 117 is used to turn the received acoustic wave into electrical energy that can be captured and stored digitally. The computer 75 acts as the “brain” of the data. acquisition system. It is used to run software to control the oscilloscope 105, control the X-Y-Z positioner 200, capture and store data from the oscilloscope 105, and to analyze the acquired data. The pulser-receiver 110 generates an electrical pulse to drive the trans ting transducer 116 to generate an acoustic wave in the air and receives the electrical signal representing the acoustic wave at the receiving transducer 117 (i.e., the reflection). Amplification of the received signal is accomplished via an in-line amplifier 120 on a receiver input of the pulser-receiver 110. Finally, the pulser-receiver 110 sends the amplified signal to an input on one channel of the oscilloscope 105. The oscilloscope 105 receives incoming signals from the pulser-receiver 110 and immediately digitizes and graphically displays them to the user of the oscilloscope 105. The oscilloscope 105 averages incoming signals to eliminate Gaussian noise. This results in a stable signal with very little noise. The stable signal can then be captured and stored internally on the oscilloscope's hard drive. Finally, when commanded by the computer oscilloscope 105 automatically transfers the stored information to the computer 75 for analysis.

In several of the embodiments, the same analysis algorithms and post-processing techniques are applied to the data automatically. In order to determine whether a single recorded waveform (a reflection from a circuit card 50, test piece, or component) is an indicator of a healthy component or of a failed component, the following analysis steps are taken. First, the header information in the raw data file is read. The sampling frequency that was used to record the data is taken from the header information along with a count of the number of samples in the file. This information is used to calculate the time duration of the acoustic waveform. The raw waveform data is then stored in an array for further analysis. Next, an algorithm is used to identify all of the peaks and troughs of the waveform above the measured noise threshold and below the negative value of the measured noise threshold. The algorithm uses this information and the measured noise level to identify the start and end of the wave in the data. The data determined to be before and after the wave in time is deleted from the file, leaving a file with only the waveform of interest contained in the data, i.e. truncated waveform data (action 700 shown in FIG. 2C). Several “features” are then extracted from the waveform data, particularly time domain and frequency domain features (action 701). The features extracted are: total energy, average rate is of change between two peaks, sample duration in time, difference in amplitude between the smallest peak above the noise level and the global maximum peak in the time domain, the time to the maximum peak from the first peak, total power, center frequency, bandwidth, maximum amplitude of the signal in the frequency domain, and the corresponding frequency at which the maximum amplitude occurs. These features are then input into a trained neural network. The neural network has been trained to use these features to determine failed and healthy test pieces or components by comparing features of the test piece or circuit card 50 to known good and known bad samples (actions 702 and 703). An individual neural network is trained for each circuit component type to which this method is applied. The output of the neural network is displayed to the user (action 604) via a GUI as either the word “Good” or “Failed” (action 703). The bulk analysis GUI output is a percentage accuracy from multiple iterations of the method described above.

In one of the embodiments of the invention, the transducer holder is attached to the X-Y-Z positioner 200 and positions the two air-coupled transducers 115 at a 45 degree angle to the top of the circuit card 50 such that maximum acoustic reflection is achieved.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A method for detecting failed electronics using acoustics, the method comprising:
moving two acoustic transducers over a test piece;
generating an acoustic wave that s directed towards the test piece;
reflecting the acoustic wave off the test piece;
receiving the reflected acoustic wave, the reflected acoustic wave having an amplitude;
adjusting distance of the transducers from the test piece such that the amplitude of the reflected acoustic wave is maximized;
amplifying the reflected acoustic wave;
sampling the reflected acoustic wave;
digitizing the reflected acoustic wave;
digitally storing data from reflected acoustic wave data;
averaging the reflected acoustic wave data and finding a sample rate;
saving the reflected acoustic wave data and the sample rate to a file;
processing the file to remove data that occurs before and after the acoustic wave in time;
extracting features from the data in the file, the features including total energy, average rate of change between two peaks, sample duration in time, difference in amplitude between a smallest peak above noise level and a global maximum peak in a time domain, time to maximum peak from a first peak, total power, center frequency, bandwidth, maximum amplitude of the acoustic wave in a frequency domain and its corresponding frequency;
inputting the extracted features into a neural network that has been trained to compare reflected features of the acoustic wave with features from acoustic wave reflections from “known good” electronics;
making a determination if the test piece is operating properly; and,
alerting a user as to health of the test piece.

2. The method of claim , wherein the transducers are adjusted to a distance such that a maximum reflection is achieved, the distance is adjusted by:
moving the acoustic transducers to an initial default distance;
moving the acoustic transducers through a predetermined distance range from above and below the initial default distance;
measuring acoustic reflection amplitude at each distance;
digitally storing the acoustic reflection amplitude found at each distance;
searching distance values to determine maximum reflection amplitude; and,
moving the transducers to the distance of the maximum reflection amplitude.

3. A system for detecting failed electronics using acoustics, the electronics disposed on a circuit card, the system comprising:
a data acquisition system for acquiring data, the data acquisition system including
two coupled transducers for generating an acoustic wave toward the circuit card and receiving the acoustic wave after it is reflected from the circuit card, and converting the acoustic wave to an electrical signal,
a pulser-receiver for generating an electrical pulse to drive the transducers and receiving the electrical signal representing the reflected acoustic wave,
an amplifier for amplifying the electrical signal,
an oscilloscope for receiving the amplified electrical signal and displaying the electrical signal from the transducer;
an X-Y-Z positioner to position the two transducers and to hold the circuit card;
a computer which runs software which controls movement of the X-Y-Z positioner, all functions of the oscilloscope, the computer further provides graphical user interfaces to a user; and,
software to post-process and analyze the data.

4. The system of claim 3, wherein the data acquisition system further includes a transducer holder for holding the two air-coupled transducers, wherein the transducer holder is attached to the X-Y-Z positioner and positions the two air-coupled transducers at a 45 degree angle to the top of the circuit card such that maximum acoustic reflection is achieved.
